(19) United States
(12) Patent Application Publication
(10) Pub. No.: US 2024/0079784 A1
(43) Pub. Date: Mar. 7, 2024

(54) Electronic Device Having Compact Grounding Structure

(71) Applicant: Apple Inc., Cupertino, CA (US)

(72) Inventors: Han Wang, Campbell, CA (US); Victor C. Lee, Santa Clara, CA (US); Jingni Zhong, Santa Clara, CA (US); Ming Chen, Cupertino, CA (US); Bhaskara R. Rupakula, San Jose, CA (US); Yiren Wang, Cupertino, CA (US); Yuan Tao, Santa Clara, CA (US); Christopher Q. Ma, San Francisco, CA (US); Zhiheng Zhou, Zhangjiagang (CN); Sherry Cao, San Francisco, CA (US); Kevin M. Froese, Verona, WI (US); Hao Xu, Cupertino, CA (US); Hongfei Hu, Cupertino, CA (US); Mattia Pascolini, San Francisco, CA (US)

(21) Appl. No.: 18/458,710

(22) Filed: Aug. 30, 2023

Related U.S. Application Data
(60) Provisional application No. 63/403,668, filed on Sep. 2, 2022.

(51) Int. Cl. H01Q 9/04; H01Q 9/40

(52) U.S. Cl. CPC H01Q 9/0414; H01Q 9/0442; H01Q 9/40

(57) ABSTRACT

An electronic device may be provided with an antenna having a resonating element and a light source module mounted to a flexible printed circuit and a metal cowling. The module may emit light through a rear housing wall. The printed circuit may be interposed between the metal cowling and a conductive support plate in the rear housing wall. The printed circuit may include a ground trace coupled to the resonating element. A dimpled pad may couple the ground trace to the support plate. Compressive foam may be used to exert a force against the flexible printed circuit that presses the dimpled pad against the conductive support plate. The ground trace and the dimpled pad may form a return path to ground for the resonating element. The dimpled pad may occupy less height within the device than other structures such as metal springs.

This application claims the benefit of U.S. Provisional Patent Application No. 63/403,668, filed Sep. 2, 2022, which is hereby incorporated by reference herein in its entirety.

### BACKGROUND

This relates generally to electronic devices and, more particularly, to electronic devices with wireless communications capabilities.

Electronic devices such as portable computers and cellular telephones are often provided with wireless communications capabilities. To satisfy consumer demand for small form factor wireless devices, manufacturers are continually striving to implement wireless communications circuitry such as antenna components using compact structures. At the same time, there is a desire for electronic devices to also include other components such as light sources.

It can be challenging to provide small form factor electronic devices with antennas that still exhibit satisfactory wireless performance despite the presence of nearby components such as light sources.

### SUMMARY

An electronic device may be provided with wireless circuitry and a housing having peripheral conductive housing structures and a rear housing wall. A display may be mounted to the housing. A segment of the peripheral conductive housing structures may be separated from ground structures by a slot. The segment may form an antenna resonating element for an antenna. The ground structures may include a conductive support plate in the rear housing wall for the device, a mid-chassis for the device, and a display module in the display.

A flexible printed circuit may at least partially overlap the slot. A light source module may be mounted to the flexible printed circuit. The light source module may also be mounted to a metal cowling. The light source module may emit light through the rear housing wall. The light source module may form a flash or strobe for a rear-facing camera on the device. A portion of the flexible printed circuit may be interposed between the metal cowling and the conductive support plate. The flexible printed circuit may include a ground trace coupled to the segment. A grounding structure may couple the ground trace to the conductive support plate.

The grounding structure may include a dimpled pad. The dimpled pad may include a conductive pad having a metal dimple or bump. A compressive foam may be interposed between the flexible printed circuit and the metal cowling. The metal cowling and the compressive foam may exert a force against the flexible printed circuit that presses the metal dimple against the conductive support plate. The ground trace and the grounding structure may form a return path to the ground for the antenna. The dimpled pad may occupy significantly less height within the device than other grounding structures such as metal springs.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is a cross-sectional side view of an illustrative electronic device having housing structures that may be used in forming antenna structures in accordance with some embodiments.

FIG. 5 is a top interior view of the upper end of an illustrative electronic device having antennas and a light source in accordance with some embodiments.

FIG. 6 is a top interior view showing how an illustrative flexible printed circuit for a light source may couple an antenna to ground in accordance with some embodiments.

FIG. 7 is a cross-sectional side view showing how an illustrative flexible printed circuit for a light source may be coupled to ground in accordance with some embodiments.

### DETAILED DESCRIPTION

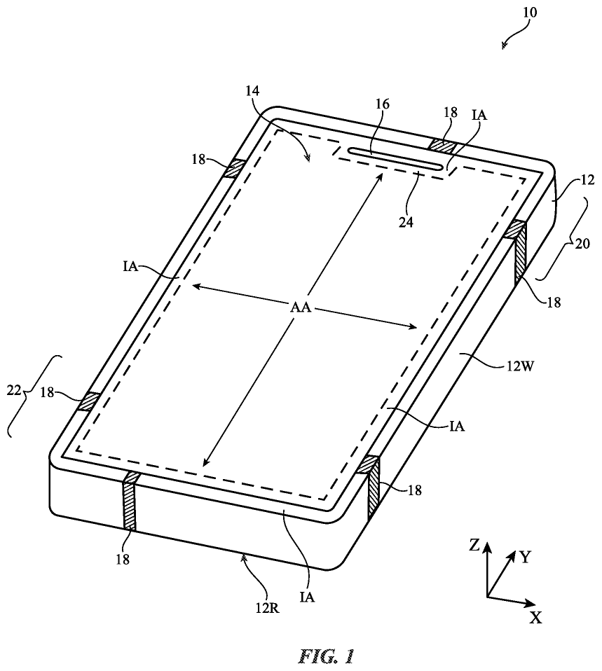

An electronic device such as electronic device 10 of FIG. 1 may be provided with wireless circuitry that includes antennas. The antennas may be used to transmit and/or receive wireless radio-frequency signals.

Device 10 may be a portable electronic device or other suitable electronic device. For example, device 10 may be a laptop computer, a tablet computer, a somewhat smaller device such as a wrist-watch device, pendant device, headphone device, earpiece device, headset device, or other wearable or miniature device, a handheld device such as a cellular telephone, a media player, or other small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region such as notch 24 that extends into active area AA. Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms notch 24 of inactive area IA). Notch 24 may be a substantially rectangular region that is surrounded (defined) on three sides by active area AA and on a fourth side by peripheral conductive housing structures 12W. One or more sensors may be aligned with notch 24 and may transmit and/or receive light through display 14 within notch 24.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in notch 24 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is merely illustrative.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is merely illustrative. If desired, housing 12 may have other shapes (e.g., a square shape, cylindrical shape, spherical shape, combinations of these and/or different shapes, etc.).

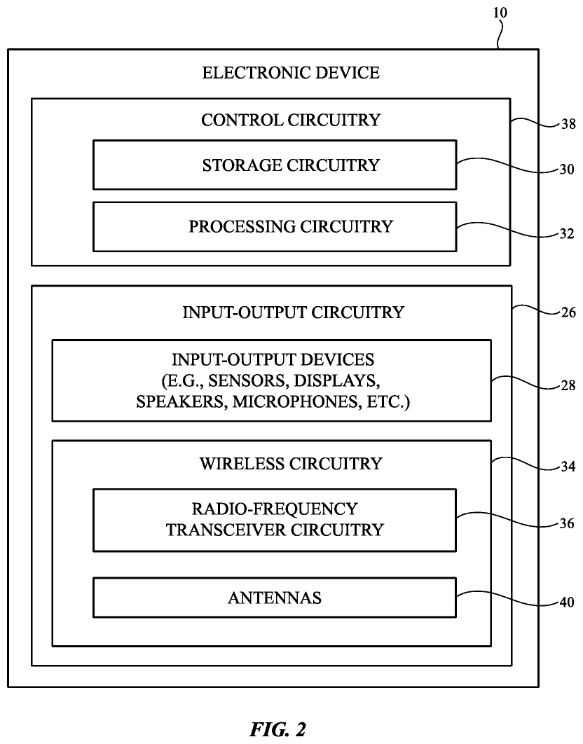

A schematic diagram of illustrative components that may be used in device 10 is shown in FIG. 2. As shown in FIG. 2, device 10 may include control circuitry 38. Control circuitry 38 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 38 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 38 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 38 may be used to run software on device 10 such as internet browsing applications, voice-over-internet-protocol (VOIP) telephone call applications, email applications, media playback applications, operating system functions, etc. To support interactions with external equipment, control circuitry 38 may be used in implementing communications protocols. Communications protocols that may be implemented using control circuitry 38 include internet protocols, wireless local area network protocols (e.g., IEEE 802.11 protocols—sometimes referred to as WiFi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 26. Input-output circuitry 26 may include input-output devices 28. Input-output devices 28 may be used to allow data to be supplied to device 10 and to allow data to be provided from device 10 to external devices. Input-output devices 28 may include user interface devices, data port devices, sensors, and other input-output components. For example, input-output devices 28 may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components. The sensors in input-output devices 28 may include front-facing sensors that gather sensor data through display 14. The front-facing sensors may be optical sensors. The optical sensors may include an image sensor (e.g., a front-facing camera), an infrared sensor, and/or an ambient light sensor. The infrared sensor may include one or more infrared emitters (e.g., a dot projector and a flood illuminator) and/or one or more infrared image sensors.

Input-output circuitry 26 may include wireless circuitry such as wireless circuitry 34 for wirelessly conveying radio-frequency signals. While control circuitry 38 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 38 (e.g., portions of control circuitry 38 may be implemented on wireless circuitry 34). As an example, control circuitry 38 may include baseband processor circuitry or other control components that form a part of wireless circuitry 34.

Wireless circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless circuitry 34 may include radio-frequency transceiver circuitry 36 for handling transmission and/or reception of radio-frequency signals within corresponding frequency bands at radio frequencies (sometimes referred to herein as communications bands or simply as “bands”). The frequency bands handled by radio-frequency transceiver circuitry 36 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz), 3G bands, 4G LTE bands, 3GPP 5G New Radio Frequency Range 1 (FR1) bands below 10 GHz, 3GPP 5G New Radio (NR) Frequency Range 2 (FR2) bands between 20 and 60 GHz, other centimeter or millimeter wave frequency bands between 10-300 GHz, near-field communications frequency bands (e.g., at 13.56 MHz), satellite navigation frequency bands such as the Global Positioning System (GPS) L1 band (e.g., at 1575 MHz), L2 band (e.g., at 1228 MHz), L3 band (e.g., at 1381 MHz), L4 band (e.g., at 1380 MHz), and/or L5 band (e.g., at 1176 MHz), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHz), communications bands under the family of 3GPP wireless communications standards, communications bands under the IEEE 802.XX family of standards, satellite communications bands such as an L-band, S-band (e.g., from 2-4 GHz), C-band (e.g., from 4-8 GHz), X-band, Ku-band (e.g., from 12-18 GHz), Ka-band (e.g., from 26-40 GHz), etc., industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

The UWB communications handled by radio-frequency transceiver circuitry 36 may be based on an impulse radio signaling scheme that uses band-limited data pulses. Radio-frequency signals in the UWB frequency band may have any desired bandwidths such as bandwidths between 499 MHz and 1331 MHz, bandwidths greater than 500 MHz, etc. The presence of lower frequencies in the baseband may sometimes allow ultra-wideband signals to penetrate through objects such as walls. In an IEEE 802.15.4 system, for example, a pair of electronic devices may exchange wireless time stamped messages. Time stamps in the messages may be analyzed to determine the time of flight of the messages and thereby determine the distance (range) between the devices and/or an angle between the devices (e.g., an angle of arrival of incoming radio-frequency signals).

Radio-frequency transceiver circuitry 36 may include respective transceivers (e.g., transceiver integrated circuits or chips) that handle each of these frequency bands or any desired number of transceivers that handle two or more of these frequency bands. In scenarios where different transceivers are coupled to the same antenna, filter circuitry (e.g., duplexer circuitry, diplexer circuitry, low pass filter circuitry, high pass filter circuitry, band pass filter circuitry, band stop filter circuitry, etc.), switching circuitry, multiplexing circuitry, or any other desired circuitry may be used to isolate radio-frequency signals conveyed by each transceiver over the same antenna (e.g., filtering circuitry or multiplexing circuitry may be interposed on a radio-frequency transmission line shared by the transceivers). Radio-frequency transceiver circuitry 36 may include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies.

In general, radio-frequency transceiver circuitry 36 may cover (handle) any desired frequency bands of interest. As shown in FIG. 2, wireless circuitry 34 may include antennas 40. Radio-frequency transceiver circuitry 36 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from stacked patch antenna structures, loop antenna structures, patch antenna structures, inverted-F antenna structures, slot antenna structures, planar inverted-F antenna structures, waveguide structures, monopole antenna structures, dipole antenna structures, helical antenna structures, Yagi (Yagi-Uda) antenna structures, hybrids of these designs, etc. If desired, antennas 40 may include antennas with dielectric resonating elements such as dielectric resonator antennas. If desired, one or more of antennas 40 may be cavity-backed antennas. Two or more antennas 40 may be arranged in a phased antenna array if desired (e.g., for conveying centimeter and/or millimeter wave signals within a signal beam formed in a desired beam pointing direction that may be steered/adjusted over time). Different types of antennas may be used for different bands and combinations of bands.

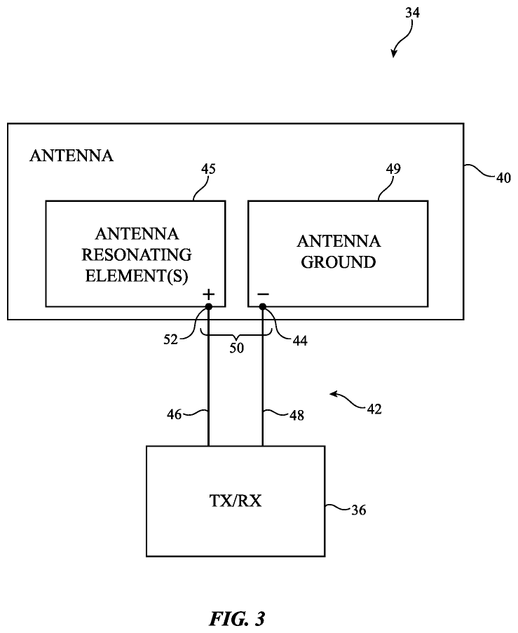

FIG. 3 is a schematic diagram showing how a given antenna 40 may be fed by radio-frequency transceiver circuitry 36. As shown in FIG. 3, antenna 40 may have a corresponding antenna feed 50. Antenna 40 may include one or more antenna resonating (radiating) elements 45 and an antenna ground 49. Antenna resonating element(s) 45 may include one or more radiating arms, slots, waveguides, dielectric resonators, patches, parasitic elements, indirect feed elements, and/or any other desired antenna radiators. Antenna feed 50 may include a positive antenna feed terminal 52 coupled to at least one antenna resonating element 45 and a ground antenna feed terminal 44 coupled to antenna ground 49. If desired, one or more conductive paths (sometimes referred to herein as ground paths, short paths, or return paths) may couple antenna resonating element(s) 45 to antenna ground 49.

Radio-frequency transceiver (TX/RX) circuitry 36 may be coupled to antenna feed 50 using a radio-frequency transmission line path 42 (sometimes referred to herein as transmission line path 42). Transmission line path 42 may include a signal conductor such as signal conductor 46 (e.g., a positive signal conductor). Transmission line path 42 may include a ground conductor such as ground conductor 48. Ground conductor 48 may be coupled to ground antenna feed terminal 44 of antenna feed 50. Signal conductor 46 may be coupled to positive antenna feed terminal 52 of antenna feed 50.

Transmission line path 42 may include one or more radio-frequency transmission lines. The radio-frequency transmission line(s) in transmission line path 42 may include stripline transmission lines (sometimes referred to herein simply as striplines), coaxial cables, coaxial probes realized by metalized vias, microstrip transmission lines, edge-coupled microstrip transmission lines, edge-coupled stripline transmission lines, waveguide structures, combinations of these, etc. Multiple types of radio-frequency transmission line may be used to form transmission line path 42. Filter circuitry, switching circuitry, impedance matching circuitry, phase shifter circuitry, amplifier circuitry, and/or other circuitry may be interposed on transmission line path 42, if desired. One or more antenna tuning components for adjusting the frequency response of antenna 40 in one or more bands may be interposed on transmission line path 42 and/or may be integrated within antenna 40 (e.g., coupled between the antenna ground and the antenna resonating element of antenna 40, coupled between different portions of the antenna resonating element of antenna 40, etc.).

If desired, one or more of the radio-frequency transmission lines in transmission line path 42 may be integrated into ceramic substrates, rigid printed circuit boards, and/or flexible printed circuits. In one suitable arrangement, the radio-frequency transmission lines may be integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All the multiple layers of the laminated structures may be batch laminated together (e.g., in a single pressing process) without adhesive (e.g., as opposed to performing multiple pressing processes to laminate multiple layers together with adhesive).

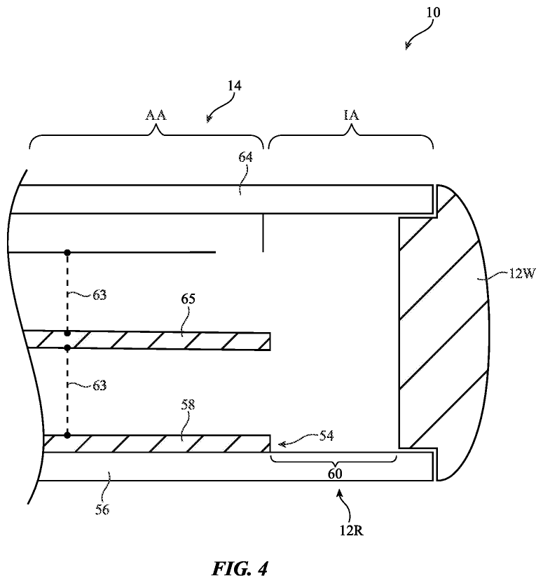

If desired, conductive electronic device structures such as conductive portions of housing 12 (FIG. 1) may be used to form at least part of one or more of the antennas 40 in device 10. FIG. 4 is a cross-sectional side view of device 10, showing illustrative conductive electronic device structures that may be used in forming one or more of the antennas 40 in device 10.

As shown in FIG. 4, peripheral conductive housing structures 12W may extend around the lateral periphery of device 10 (e.g., as measured in the X-Y plane of FIG. 1). Peripheral conductive housing structures 12W may extend from rear housing wall 12R (e.g., at the rear face of device 10) to display 14 (e.g., at the front face of device 10). In other words, peripheral conductive housing structures 12W may form conductive sidewalls for device 10, a first of which is shown in the cross-sectional side view of FIG. 4 (e.g., a given sidewall that runs along an edge of device 10 and that extends across the width or length of device 10).

Display 14 may have a display module such as display module 62 (sometimes referred to as a display panel). Display module 62 may include pixel circuitry, touch sensor circuitry, force sensor circuitry, and/or any other desired circuitry for forming active area AA of display 14. Display 14 may include a dielectric cover layer such as display cover layer 64 that overlaps display module 62. Display cover layer 64 may include plastic, glass, sapphire, ceramic, and/or any other desired dielectric materials. Display module 62 may emit image light and may receive sensor input (e.g., touch and/or force sensor input) through display cover layer 64. Display cover layer 64 and display 14 may be mounted to peripheral conductive housing structures 12W. The lateral area of display 14 that does not overlap display module 62 may form inactive area IA of display 14.

As shown in FIG. 4, rear housing wall 12R may be mounted to peripheral conductive housing structures 12W (e.g., opposite display 14). Rear housing wall 12R may include a conductive layer such as conductive support plate 58. Conductive support plate 58 may extend across an entirety of the width of device 10 (e.g., between the left and right edges of device 10 as shown in FIG. 1). Conductive support plate 58 may be formed from an integral portion of peripheral conductive housing structures 12W that extends across the width of device 10 or may include a separate housing structure attached, coupled, or affixed to peripheral conductive housing structures 12W.

If desired, rear housing wall 12R may include a dielectric cover layer such as dielectric cover layer 56. Dielectric cover layer 56 may include glass, plastic, sapphire, ceramic, one or more dielectric coatings, or other dielectric materials. Dielectric cover layer 56 may be layered under conductive support plate 58 (e.g., conductive support plate 58 may be coupled to an interior surface of dielectric cover layer 56). If desired, dielectric cover layer 56 may extend across an entirety of the width of device 10 and/or an entirety of the length of device 10. Dielectric cover layer 56 may overlap slot 60. If desired, dielectric cover layer 56 be provided with pigmentation and/or an opaque masking layer (e.g., an ink layer) that helps to hide the interior of device 10 from view. In another suitable arrangement, dielectric cover layer 56 may be omitted and slot 60 may be filled with a solid dielectric material.

The housing for device 10 may also include one or more additional conductive support plates interposed between display 14 and rear housing wall 12R. For example, the housing for device 10 may include a conductive support plate such as mid-chassis 65 (sometimes referred to herein as conductive support plate 65). Mid-chassis 65 may be vertically interposed between rear housing wall 12R and display 14 (e.g., conductive support plate 58 may be located at a first distance from display 14 whereas mid-chassis 65 is located at a second distance that is less than the first distance from display 14). Mid-chassis 65 may extend across an entirety of the width of device 10 (e.g., between the left and right edges of device 10 as shown in FIG. 1). Mid-chassis 65 may be formed from an integral portion of peripheral conductive housing structures 12W that extends across the width of device 10 or may include a separate housing structure attached, coupled, or affixed to peripheral conductive housing structures 12W. One or more components may be supported by mid-chassis 65 (e.g., logic boards such as a main logic board, a battery, etc.) and/or mid-chassis 65 may contribute to the mechanical strength of device 10. Mid-chassis 65 may be formed from metal (e.g., stainless steel, aluminum, etc.).

Conductive support plate 58, mid-chassis 65, and/or display module 62 may have an edge 54 that is separated from peripheral conductive housing structures 12W by dielectric-filled slot 60 (sometimes referred to herein as opening 60, gap 60, or aperture 60). Slot 60 may be filled with air, plastic, ceramic, or other dielectric materials. Conductive housing structures such as conductive support plate 58, mid-chassis 65, conductive portions of display module 62, and/or peripheral conductive housing structures 12W (e.g., the portion of peripheral conductive housing structures 12W opposite conductive support plate 58, mid-chassis 65, and display module 62 at slot 60) may be used to form antenna structures for one or more of the antennas 40 in device 10.

For example, peripheral conductive housing structures 12W may form an antenna resonating element arm (e.g., an inverted-F antenna resonating element arm) in the antenna resonating element 45 of an antenna 40 in device 10. Mid-chassis 65, conductive support plate 58, and/or display module 62 may be used to form the antenna ground 49 (FIG. 3) for one or more of the antennas 40 in device 10 and/or to form one or more edges of slot antenna resonating elements for the antennas in device 10. One or more conductive interconnect structures 63 may electrically couple mid-chassis 65 to conductive support plate 58 and/or one or more conductive interconnect structures 63 may electrically couple mid-chassis 65 to conductive structures in display module 62 (sometimes referred to herein as conductive display structures) so that each of these elements form part of the antenna ground. The conductive display structures may include a conductive frame, bracket, or support for display module 62, shielding layers in display module 62, ground traces in display module 62, etc.

Conductive interconnect structures 63 may serve to ground mid-chassis 65 to conductive support plate 58 and/or display module 62 (e.g., to ground conductive support plate 58 to the conductive display structures through mid-chassis 65). Put differently, conductive interconnect structures 63 may hold the conductive display structures, mid-chassis 65, and/or conductive support plate 58 to a common ground or reference potential (e.g., as a system ground for device 10 that is used to form part of antenna ground 49 of FIG. 3). Conductive interconnect structures 63 may therefore sometimes be referred to herein as grounding structures 63, grounding interconnect structures 63, or vertical grounding structures 63. Conductive interconnect structures 63 may include conductive traces, conductive pins, conductive springs, conductive prongs, conductive brackets, conductive screws, conductive clips, conductive tape, conductive wires, conductive traces, conductive foam, conductive adhesive, solder, welds, metal members (e.g., sheet metal members), contact pads, conductive vias, conductive portions of one or more components mounted to mid-chassis 65 and/or conductive support plate 58, and/or any other desired conductive interconnect structures.

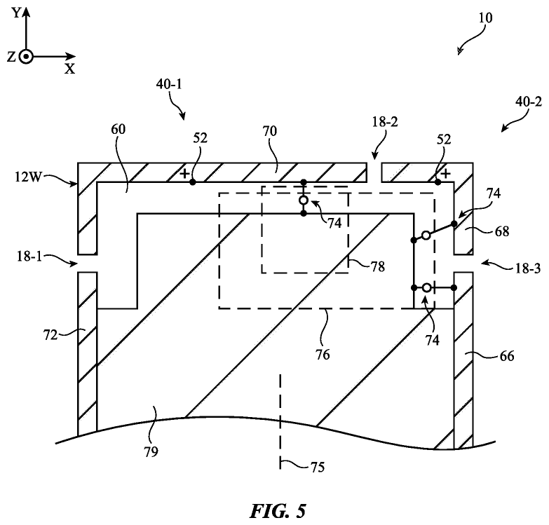

If desired, device 10 may include multiple slots 60 and peripheral conductive housing structures 12W may include multiple dielectric gaps that divide the peripheral conductive housing structures into segments (e.g., dielectric gaps 18 of FIG. 1). FIG. 5 is a top (front) interior view showing how the upper end of device 10 (e.g., within region 20 of FIG. 1) may include a slot 60 and may include multiple dielectric gaps that divide the peripheral conductive housing structures into segments for forming multiple antennas. Display 14 and other internal components have been removed from the view shown in FIG. 5 for the sake of clarity.

As shown in FIG. 5, peripheral conductive housing structures 12W may include a first conductive sidewall at the left edge of device 10, a second conductive sidewall at the top edge of device 10, a third conductive sidewall at the right edge of device 10, and a fourth conductive sidewall at the bottom edge of device 10 (not shown in FIG. 5). Peripheral conductive housing structures 12W may be segmented by dielectric-filled gaps 18 such as a first gap 18-1, a second gap 18-2, and a third gap 18-3. Gaps 18-1, 18-2, and 18-3 may be filled with plastic, ceramic, sapphire, glass, epoxy, or other dielectric materials. The dielectric material in the gaps may lie flush with peripheral conductive housing structures 12W at the exterior surface of device 10 if desired.

Gap 18-1 may divide the first conductive sidewall to separate segment 72 of peripheral conductive housing structures 12W from segment 70 of peripheral conductive housing structures 12W. Gap 18-2 may divide the second conductive sidewall to separate segment 70 from segment 68 of peripheral conductive housing structures 12W. Gap 18-3 may divide the third conductive sidewall to separate segment 68 from segment 66 of peripheral conductive housing structures 12W. In this example, segment 70 forms the upper-left corner of device 10 (e.g., segment 68 may have a bend at the corner) and is formed from the first and second conductive sidewalls of peripheral conductive housing structures 12W (e.g., in upper region 20 of FIG. 1).

Device 10 may include ground structures 79 (e.g., structures that form part of antenna ground 49 of FIG. 3 for one or more of the antennas in device 10). Ground structures 79 may include one or more metal layers such conductive support plate 58 (FIG. 4), mid-chassis 65 (FIG. 4), conductive display structures in display module 62 (FIG. 4), conductive interconnect structures 63 (FIG. 4), conductive traces on a printed circuit board, conductive portions of one or more components in device 10, etc. Ground structures 79 may extend between opposing sidewalls of peripheral conductive housing structures 12W. For example, ground structures 79 may extend from segment 72 to segment 66 of peripheral conductive housing structures 12W (e.g., across the width of device 10, parallel to the X-axis of FIG. 5). Ground structures 79 may be welded or otherwise affixed to segments 66 and 72. In another suitable arrangement, some or all of ground structures 79, segment 66, and segment 72 may be formed from a single, integral (continuous) piece of machined metal (e.g., in a unibody configuration).

Ground structures 79 may define an edge of slot 60 and may be separated from peripheral conductive housing structures 12W by slot 60. Device 10 may have a longitudinal axis 75 that bisects the width of device 10 and that runs parallel to the length of device 10 (e.g., parallel to the Y-axis). As shown in FIG. 5, slot 60 may separate ground structures 79 from segments 68 and 70 of peripheral conductive housing structures 12W (e.g., the upper edge of slot 60 may be defined by segments 68 and 70 whereas the lower edge of slot 60 is defined by ground structures 79). Slot 60 may have an elongated shape extending from a first end at gap 18-1 to an opposing second end at gap 18-2 (e.g., slot 60 may span the width of device 10). Slot 60 may be filled with air, plastic, glass, sapphire, epoxy, ceramic, or other dielectric material. Slot 60 may be continuous with gaps 18-1, 18-2, and 18-3 in peripheral conductive housing structures 12W if desired (e.g., a single piece of dielectric material may be used to fill both slot 60 and gaps 18-1, 18-2, and 18-3).

Ground structures 79, segment 66, segment 68, segment 70, and portions of slot 60 may be used in forming multiple antennas 40 in the upper region of device 10 (sometimes referred to herein as lower antennas). For example, device 10 may include a first antenna 40-1 having an antenna resonating (radiating) element 45 (FIG. 3) that includes an antenna arm formed from segment 70, a positive antenna feed terminal 52 coupled to segment 70, and an antenna ground 49 (FIG. 3) formed from ground structures 79. Device 10 may also include a second antenna 40-2 having an antenna resonating element formed from segment 68, a positive antenna feed terminal 52 coupled to segment 68, and an antenna ground formed from ground structures 79. Antennas 40-1 and 40-2 may be, for example, inverted-F antennas having one or more return paths 74 that couple the antenna resonating elements 45 (FIG. 3) of the antennas to antenna ground 49 (e.g., ground structures 79) across slot 60.

There may be, for example, one or more return paths 74 coupled between segment 70 and ground structures 79 (e.g., for antenna 40-1), between segment 68 and ground structures 79 (e.g., for antenna 40-2), and/or between segment 66 and ground structures 79 (e.g., for antenna 40-2 or another antenna in device 10). One or more tuning elements (e.g., tuning circuitry integrated into one or more tuners) may be disposed on one or more of the return paths 74 if desired. The tuning elements may be integrated into one or more tuners and may, for example, be used to tune and/or adjust the frequency response of the corresponding antenna 40. Return paths 74 may sometimes also be referred to herein as ground paths 74 (e.g., ground paths between antenna resonating element 45 and antenna ground 49 of FIG. 3) or short paths 74.

Device 10 may include optical components that overlap the area/volume of antennas 40-1 and/or 40-2 (e.g., that at least partially overlap slot 60). The optical components may include one or more light sources. The light source(s) may emit light through rear housing wall 12R of device 10 (FIGS. 1 and 3). The light source(s) may be integrated into a light source module 78 (sometimes referred to herein as light source assembly 78). The light source(s) may, for example, include a strobe or flash source (emitter) for a rear-facing camera on device 10 (e.g., that emit strobe or flash light to illuminate a scene for imaging with the rear-facing camera) and/or a flashlight application running on device 10. Light source module 78 may therefor sometimes be referred to herein as flash module or assembly 78, strobe module or assembly 78, or simply as optical module or assembly 78.

Light source module 78 may be mounted to and/or supported by a printed circuit such as flexible printed circuit 76 (sometimes referred to herein as strobe flex 76 or flash flex 76). Flexible printed circuit 76 may at least partially overlap the volume/area of antenna 40-1, antenna 40-2, and/or slot 60. While described herein as a flexible printed circuit, flexible printed circuit 76 may be replaced with a rigid printed circuit board if desired. Flexible printed circuit 76 may include conductive paths (lines) that are used to power, control, and/or drive light source module 78 (e.g., to control how and when the light source(s) in light source module 78 emit light through the rear housing wall).

Flexible printed circuit 76 may also be used to carry radio-frequency signals (antenna currents) for one or both of antennas 40-1 and 40-2. For example, flexible printed circuit 76 may include conductive paths (lines) that couple segment 70, segment 68, and/or segment 66 to ground structures 79 (e.g., antenna ground 49 of FIG. 3 for antennas 40-1 and/or 40-2). These conductive paths may sometimes be referred to herein as ground paths, return paths, or short paths and may form part of one or more of the return paths 74 between segment 70, segment 68, and/or segment 66 and ground structures 79. The ground paths may include ground traces on flexible printed circuit 76 and other conductive interconnect structures that couple peripheral conductive housing structures 12W and/or the ground traces to ground structures 79. The ground paths may pass radio-frequency signals (antenna currents) from segment 70, segment 68, and/or segment 66 to ground structures 79.

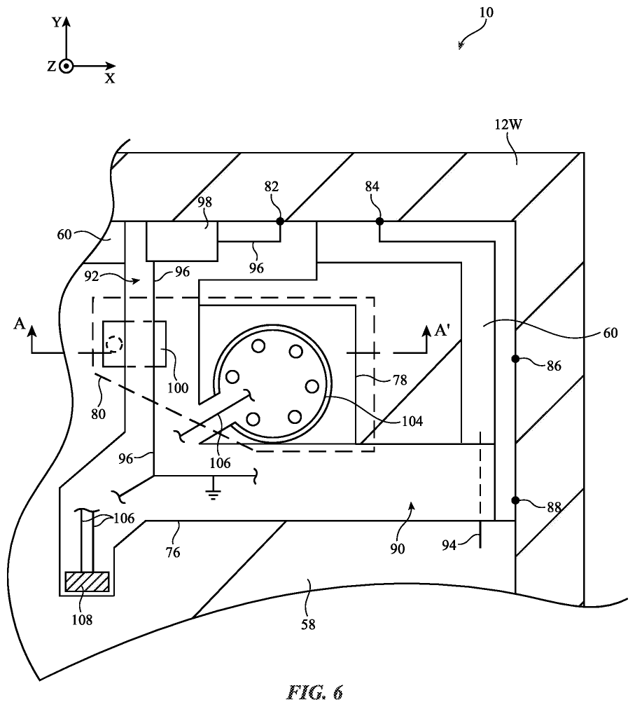

FIG. 6 is a top view showing how flexible printed circuit 76 may form a ground path from peripheral conductive housing structures 12W to ground structures 79. As shown in FIG. 6, flexible printed circuit 76 may have a connector 108 (e.g., a board-to-board connector), a first portion 92 (e.g., a first arm or tail) extending from connector 108, and a second portion 90 (e.g., a second arm or tail) extending from connector 108 and first portion 92. Second portion 90 may have an end that is folded upwards about axis 94 to extend along the inner (interior) surface of peripheral conductive housing structures 12W (e.g., along the third and second sidewalls of device 10). First portion 92 may have an end that extends along the inner (interior) surface of peripheral conductive housing structures 12W (e.g., along the second sidewall of device 10).

Flexible printed circuit 76 may have a third portion 104 (e.g., a stub, tab, or tail of the flexible printed circuit). Third portion 104 may extend from the intersection of portions 90 and 92, for example. Light source module 78 may be mounted or coupled to third portion 104 of flexible printed circuit 76. Light source module 78 may include one or more light sources (e.g., optical emitters) that emit light in the −Z direction through the rear housing wall of device 10.

Flexible printed circuit 76 may include ground traces 96. Ground traces 96 may be held at a ground potential and may be coupled to ground structures 79 (FIG. 5) at one or more locations. Flexible printed circuit 76 may include conductive paths 106 coupled to connector 108. Conductive paths 106 may include conductive traces on the substrate of flexible printed circuit 76 (e.g., a flexible printed circuit substrate) and may sometimes also be referred to herein as conductive traces 106 or conductive lines 106. Conductive paths 106 may include ground traces 96 (ground paths), signal paths (e.g., signal traces that extend into third portion 104 and that drive or otherwise control light source module 78 to emit light, signal traces for one or more antennas in device 10, etc.), control paths (e.g., for controlling light source module 78 and/or other components on flexible printed circuit 76), power lines (e.g., for powering light source module 78 and/or other components on flexible printed circuit 76), and/or any other desired paths for conveying electrical signals through flexible printed circuit 76.

Conductive paths 106 on flexible printed circuit 76 (e.g., ground traces 96) may be coupled to peripheral conductive housing structures 12W at one or more locations. For example, second portion 90 of flexible printed circuit 76 may be coupled to peripheral conductive housing structures 12W at a first location (terminal) 84, a second location (terminal) 86, and/or a third location (terminal) 88. Location 84 may be along the second sidewall whereas locations 86 and 88 are along the third sidewall of device 10, for example. First portion 92 of flexible printed circuit 76 may be coupled to peripheral conductive housing structures 12W at a fourth location (terminal) 82.

In the example of FIG. 6, gaps 18 of FIG. 5 have been omitted for the sake of clarity. As one example, location 82 may be on segment 70 of FIG. 5 (e.g., the antenna resonating element for antenna 40-1) whereas locations 84 and 86 are on segment 68 (e.g., the antenna resonating element for antenna 40-2) and location 88 is on segment 66. This is merely illustrative and, in general, locations 82, 84, 86, and 88 may be on any desired segment(s) of peripheral conductive housing structures 12W. Flexible printed circuit 76 may be coupled to peripheral conductive housing structures 12W at any number of different location(s).

Different conductive interconnect structures may be used to couple peripheral conductive housing structures 12W to conductive paths 106 on flexible printed circuit 76 at respective locations 82, 84, 86, and 88. The conductive interconnect structures may include, for example, conductive traces, conductive pins, conductive springs, conductive prongs, conductive brackets, conductive screws, conductive clips, conductive tape, conductive wires, conductive foam, conductive adhesive, solder, welds, metal members (e.g., sheet metal members), contact pads, conductive vias, and/or any other desired conductive interconnect structures.

Ground traces 96 may be used to couple peripheral conductive housing structures 12W (e.g., the antenna resonating element for one or both of antennas 40-1 and 40-2 of FIG. 5) to ground. For example, ground traces 96 may be coupled to peripheral conductive housing structures 12W at least at location 82 (and optionally at one or more of locations 84, 86, and 88). A conductive interconnect structure 100 may couple ground traces 96 on flexible printed circuit 76 to ground structures 79 (FIG. 5) at least at one location. For example, as shown in FIG. 6, flexible printed circuit 76 may at least partially overlap the underlying conductive support plate 58 in ground structures 79 (FIG. 5). Conductive interconnect structure 100 may couple ground traces 96 to conductive support plate 58. This may form a return path (e.g., a return path 74 for antenna 40-1 of FIG. 5) from location 82 on peripheral conductive housing structures 12W (e.g., segment 70 of FIG. 5) to conductive support plate 58 (e.g., the antenna ground for antenna 40-1). Conductive interconnect structure 100 may therefore sometimes be referred to herein as grounding structure 100. Antenna tuning circuitry such as tuner 98 may be interposed on ground traces 96 between conductive interconnect structure 100 and location 82 and may be mounted to flexible printed circuit 76. Ground traces 96 may also be used to couple one or more components on flexible printed circuit 76 such as one or more components in tuner 98 to ground structures 79 (FIG. 5).

Tuner 98 may include one or more tuning elements (e.g., aperture tuners), impedance matching circuitry, radio-frequency couplers, switches, signal lines, ground paths, filter circuitry, resistors, inductors (e.g., fixed or adjustable inductors), capacitors (e.g., fixed or adjustable capacitors), and/or any other desired radio-frequency circuitry for tuning, adjusting, and/or affecting the radio-frequency performance or frequency response of the corresponding antenna (e.g., antenna 40-1 of FIG. 5). Some or all of the components in the tuner may be mounted to flexible printed circuit 76 using surface mount technology (SMT) (e.g., some or all of the components in the tuner may be SMT components). The components of tuner 98 may be enclosed within an electromagnetic shield, an encapsulation layer, and/or a protective overmold (e.g., an injection-molded plastic cap). Tuner 98 may receive control signals over one or more control lines in conductive paths 106. The control signals may adjust one or more components of tuner 98 (e.g., may adjust the state of switching circuitry in tuner 98, may adjust the inductance of an adjustable inductor in tuner 98, may adjust the capacitance of an adjustable capacitor in tuner 98, etc.). Tuner 98 may be used to tune the frequency response of antenna 40-1 (FIG. 5) and the control signals may be used to change the frequency response of antenna 40-1 over time, for example.

As shown in FIG. 6, light source module 78 may include a frame, housing structure, bracket, or support structure such as light source cowling 80. Light source cowling 80 (sometimes referred to herein as light source module cowling 80, strobe cowling 80, flash cowling 80, cowling 80, frame 80, light source frame 80, light source housing 80, light source module housing 80, light source module frame 80, or light source bracket 80) may be disposed over light source module 78. Light source module 78 may be attached, secured, mounted to, or otherwise supported by light source cowling 80. Light source cowling 80 may help to hold light source module 78 in place, may help to electromagnetically and/or physically shield light source module 78 from other components in device 10 and/or to shield other components in device 10 from light source module 78, may contribute to the mechanical integrity of light source module 78 and/or device 10, etc. Light source cowling 80 may be formed from metal or other sufficiently rigid materials (e.g., bent or folded sheet metal). Light source cowling 80 may be attached, affixed, secured, or otherwise coupled to one or more other components in device 10 such as conductive support plate 58. Light source cowling 80 may, if desired, help to secure conductive interconnect structure 100 in place in contact with conductive support plate 58.

While illustrated as coupling location 82 on peripheral conductive housing structures 12W to ground (e.g., conductive support plate 58), conductive interconnect structure 100 may additionally couple one or more of locations 84, 86, and 88 to ground (e.g., by coupling ground traces 96 coupled to locations 84, 86, and/or 88 to conductive support plate 58). Additionally or alternatively, additional conductive interconnect structures 100 may be disposed at other locations on flexible printed circuit 76 for coupling one or more of locations 84, 86, and 88 to conductive support plate 58. Conductive interconnect structure 100 may couple ground traces 96 to other portions of ground structures 79 if desired (e.g., mid-chassis 65 or display module 62 of FIG. 4).

In general, conductive interconnect structure 100 may include conductive traces (e.g., a conductive pad), conductive pins, conductive springs, conductive prongs, conductive brackets, conductive screws, conductive clips, conductive tape, conductive wires, conductive foam, conductive adhesive, solder, welds, metal members (e.g., sheet metal members), contact pads, conductive vias, and/or any other desired conductive interconnect structures. In some implementations, conductive interconnect structure 100 includes a conductive clip or a conductive spring. However, conductive clips and springs include bent metal members that consume an excessive amount of space in device 10, particularly in a direction parallel to the Z-axis. This can limit how small device 10 can be (e.g., can create a limit on the thinness of device 10) and/or can prevent device 10 from fitting other components within its interior.

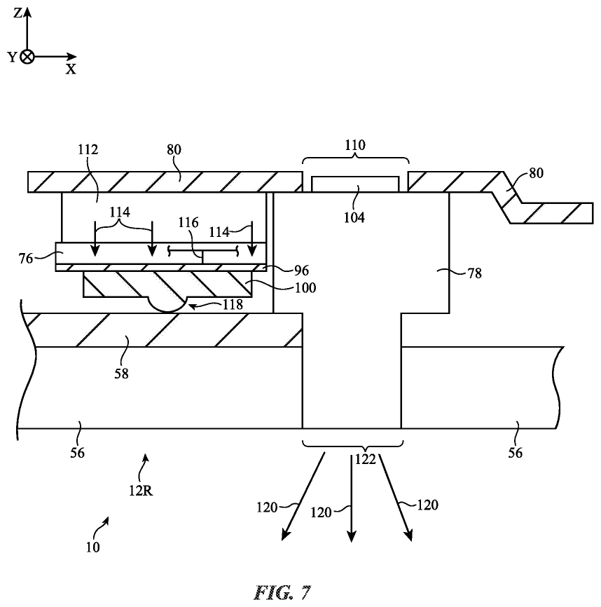

To mitigate these issues in grounding peripheral conductive housing structures 12W (e.g., antennas 40-1 and/or 40-2 of FIG. 6) to conductive support plate 58 while consuming a minimum amount of volume (e.g., parallel to the Z-axis), conductive interconnect structure 100 may include a dimpled pad. FIG. 7 is a cross-sectional side view (e.g., as taken in the direction of line AA′ of FIG. 6) showing how conductive interconnect structure 100 may include a dimpled pad.

As shown in FIG. 7, dielectric cover layer 56 of rear housing wall 12R may have an opening 122. Light source module 78 may be aligned with and at least partially disposed within opening 122 (e.g., a portion of light source module 78 may protrude through dielectric cover layer 56). Light source module 78 may include one or more light sources (sometimes referred to herein as light emitters or optical emitters). The light sources may include light-emitting diodes (LEDs), lasers, OLEDs, or any other desired light sources (e.g., light sources that are not integrated into a display that displays images using an array of display pixels). The light sources in light source module 78 may emit light 120 through rear housing wall 12R. Light 120 may illuminate a scene behind the rear face of device 10. The light sources may include, for example, one or more strobe or flash sources (e.g., light 120 may be a flash or a strobe light). If desired, the light sources may emit light 120 when a rear-facing camera on device 10 captures images. Light source module 78 may include one or more lenses and/or one or more optical diffusers for directing how light 120 is emitted from light source module 78. Light source module 78 may also include a housing that encloses the light sources, lenses, and/or diffusers.

Light source module 78 may be mounted to portion 104 of flexible printed circuit 76 and to light source cowling 80. Portion 104 of flexible printed circuit 76 may include signal lines, power lines, and/or control lines (e.g., conductive paths 106 of FIG. 6) coupled to light source module 78. Portion 104 may be disposed within or overlapping an opening 110 in light source cowling 80. Light source cowling 80 may be disposed over light source module 78 (e.g., light source module 78 may be interposed between light source cowling 80 and dielectric cover layer 56) and may help to hold light source module 78 in place on (in) dielectric cover layer 56 (e.g., light source cowling 80 may serve as a bracket that holds light source module 78 in place).

As shown in FIG. 7, flexible printed circuit 76 may also be mounted to light source cowling 80. A dielectric material such as compressive foam 112 may couple flexible printed circuit 76 to light source cowling 80 (e.g., compressive foam 112 may be interposed between light source cowling 80 and flexible printed circuit 76 and flexible printed circuit 76 may be mounted to light source cowling 80 through compressive foam 112). Compressive foam 112 may be a conductive foam or a dielectric foam. One or both lateral surfaces of compressive foam 112 (e.g., contacting light source cowling 80 and flexible printed circuit 76) may be adhesive if desired. Conductive support plate 58 may be layered onto dielectric cover layer 56 and may be interposed between flexible printed circuit 76 and dielectric cover layer 56. Conductive interconnect structure 100 may couple ground traces 96 on flexible printed circuit 76 to conductive support plate 58. Ground traces 96 may include conductive traces on the surface of flexible printed circuit 76 (e.g., at least a grounded contact pad) and may, if desired, include conductive traces embedded within the layers of flexible printed circuit 76 (e.g., internal to flexible printed circuit 76) that are coupled to the conductive traces on the surface by one or more conductive vias 116.

Conductive interconnect structure 100 may be coupled to the ground traces 96 on the surface of flexible printed circuit 76 (e.g., using solder). Conductive interconnect structure 100 may be, for example, a dimpled contact pad sometimes referred to as a dimpled pad. The dimpled pad may include metal or other conductive materials having one or more dimples 118 that protrude away from flexible printed circuit 76. Dimples 118 include protruding solid portions of rigid conductive material that are integral to conductive interconnect structure 100 (e.g., formed from an integral portion of conductive interconnect structure 100). Dimples 118 may be machined, etched, deposited, or otherwise integrated into conductive interconnect structure 100 (e.g., unlike a conductive spring, dimples 118 may be rigid and may not exert a spring force when subject to a compressive force). Dimples 118 may sometimes be referred to herein as protrusions 118 or bumps 118. Each dimple 118 may contact conductive support plate 58 at a single respective point. Each dimple 118 may therefore form a precise contact point to ground (conductive support plate 58) for ground traces 96 on flexible printed circuit 76 (and thus for the antenna(s) formed from peripheral conductive housing structures 12W that are coupled to ground traces 96 as shown in FIG. 5). Conductive interconnect structure 100 may sometimes be referred to herein as dimple pad 100 or dimpled pad 100.

As shown in FIG. 7, light source cowling 80 may hold compressive foam 112 in place on flexible printed circuit 76. When compressed, compressive foam 112 may exert a downward biasing (spring) force 114 (e.g., in the −Z direction) onto flexible printed circuit 76. Flexible printed circuit 76 may transfer this downward force into conductive interconnect structure 100. Force 114 may then serve to press and hold dimple 118 in place on (against) conductive support plate 58. In other words, compressive foam 112 may be compressed and held into place by (e.g., sandwiched between) rigid structures such as light source cowling 80 and conductive support plate 58. When compressed, compressive foam 112 exerts force 114 onto flexible printed circuit 76 and conductive interconnect structure 100, pressing and holding dimple 118 in place at the grounding point on conductive support plate 58. This may serve to provide a robust electrical connection between ground traces 96 and conductive support plate 58 that will remain in place over time during normal operation of device 10 (e.g., even as device 10 is subjected to external forces that may otherwise cause dimple 118 to slide out of place).

In this way, conductive interconnect structure 100 may form part of the ground path for the antenna(s) coupled to ground traces 96. The ground path may allow the antenna(s) to radiate as an inverted-F antenna resonating element and/or may help to electromagnetically decouple the antenna(s) from other electronic or conductive components in the volume of the antenna(s), thereby maximizing antenna performance despite the presence of other components such as light source module 78 overlapping the antenna(s). Conductive interconnect structure 100 is substantially planar and is thus as compact as possible in the dimension of device 10 parallel to the Z-axis. Conductive interconnect structure 100 may therefore occupy significantly less volume in device 10 (particularly parallel to the Z-axis) than conductive springs, brackets, or screws, thereby allowing device 10 have a form factor that is as thin as possible and/or allowing for other components to be mounted in device 10 without sacrificing antenna performance.

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made by those skilled in the art without departing from the scope and spirit of the described embodiments. The foregoing embodiments may be implemented individually or in any combination.

What is claimed is:

1. An electronic device comprising:
ground structures;
peripheral conductive housing structures having a segment separated from the ground structures by a slot and forming at least part of an antenna resonating element for an antenna;
a printed circuit at least partially overlapping the slot and having a ground trace coupled to the segment; and
a dimpled pad that couples the ground trace to the ground structures.

2. The electronic device of claim 1, further comprising:
a metal cowling, the printed circuit being interposed between the metal cowling and the dimpled pad and the dimpled pad being interposed between the printed circuit and the ground structures.

3. The electronic device of claim 2, further comprising:
a compressive foam interposed between the metal cowling and the printed circuit, the compressive foam being configured to exert a force against the printed circuit.

4. The electronic device of claim 3, further comprising:
a light source module mounted to the metal cowling and the printed circuit, wherein the printed circuit comprises a conductive path coupled to the light source module.

5. The electronic device of claim 4, further comprising:
a housing wall having a dielectric cover layer and a conductive support plate on the dielectric cover layer, the ground structures comprising the conductive support plate and the light source module being configured to emit light through the housing wall.

6. The electronic device of claim 5, further comprising:
an opening in the dielectric cover layer, wherein at least part of the light source module is disposed within the opening.

7. The electronic device of claim 1, further comprising:
a tuner for the antenna, the tuner being mounted to the printed circuit and disposed on the ground trace.

8. The electronic device of claim 1, wherein the peripheral conductive housing structures comprise an additional segment separated from the segment by a gap, the printed circuit comprising a conductive path coupled to the additional segment.

9. The electronic device of claim 1, wherein the printed circuit comprises a flexible printed circuit and the dimpled pad is soldered to the ground trace.

10. An electronic device comprising:
a conductive layer;
a metal cowling;
a light source mounted to the metal cowling;
a flexible printed circuit mounted to the metal cowling;
a ground trace on the flexible printed circuit; and
a grounding structure that couples the ground trace to the conductive layer, wherein the grounding structure comprises a metal bump that contacts the conductive layer.

11. The electronic device of claim 10, further comprising:
a compressive foam interposed between the flexible printed circuit and the metal cowling.

12. The electronic device of claim 11, wherein the compressive foam is configured to exert a force on the flexible printed circuit that presses the bump against the conductive layer.

13. The electronic device of claim 10, wherein the grounding structure comprises an additional metal bump that contacts the conductive layer.

14. The electronic device of claim 10, further comprising:
a display; and
a dielectric cover layer opposite the display, wherein the conductive layer is layered onto the dielectric cover layer and the light source is configured to emit light through an opening in the dielectric cover layer.

15. The electronic device of claim 14, further comprising:
a camera, wherein the light source comprises a flash for the camera.

16. The electronic device of claim 14, further comprising:
peripheral conductive housing structures, the dielectric cover layer and the display being mounted to the peripheral conductive housing structures; and
an antenna resonating element formed from a segment of the peripheral conductive housing structures, the ground trace being coupled to a terminal on the segment.

17. The electronic device of claim 10, wherein the metal cowling has an opening, the flexible printed circuit has a portion overlapping the opening, the light source is mounted to the portion of the flexible printed circuit, and the flexible printed circuit comprises a conductive path that transmits signals to the light source.

18. An electronic device comprising:
a conductive housing layer;
a display opposite the conductive housing layer;
a rear-facing camera opposite the display;
a light source mounted to a bracket and configured to produce a flash for the rear-facing camera;
a printed circuit having a ground trace; and
a conductive pad coupled to the ground trace and having a dimple that contacts the conductive housing layer, wherein the bracket is configured to hold the printed circuit and the conductive pad against the conductive housing layer.

19. The electronic device of claim 18, further comprising:
a compressive foam configured to exert a force against the printed circuit, wherein the compressive foam, the flexible printed circuit, and the conductive pad are sandwiched between the conductive housing layer and the bracket.

20. The electronic device of claim 18, further comprising:
an antenna having an antenna resonating element and a return path from the antenna resonating element to the conductive housing layer, wherein the ground trace and the conductive pad form part of the return path.
